(19) United States
(12) Patent Application Publication
(10) Pub. No.: US 2009/0226630 A1
(43) Pub. Date: Sep. 10, 2009

(54) Solder Paste and Method for Forming Solder Bumps Using the Same

(76) Inventor: Sang Jun Bae, Gyeonggi-do (KR)

Correspondence Address: THOMAS, KAYDEN, HORSTEMEYER & RISLEY, LLP, 600 GALLERIA PARKWAY, S.E., STE 1500, ATLANTA, GA, 30339-5994, US

(21) Appl. No.: 12/301,629

(22) PCT Filed: Jun. 15, 2007
(86) PCT No.: PCT/KR07/02904

§ 371 Date: Nov. 20, 2008

(30) Foreign Application Priority Data
Jun. 15, 2006 (KR) 10-2006-0053845

(51) Int. Cl. B05D 3/06; B23K 35/363

(52) U.S. Cl. 427/510; 148/24

(57) ABSTRACT

The present invention relates to a solder paste containing 70 to 90 wt % of a solder powder having the melting point of 100 to 250° C.; 5 to 15 wt % of an ultraviolet curable or degradable photosensitive polymer; 0.5 to 2 wt % of an additive; and 4.5 to 13 wt % of a composite solvent, and a method for forming solder bumps using the solder paste. The solder bumps can be formed so as to have a fine width of a few or a few tens of micrometers, thereby easily achieving miniaturization and increased integration of semiconductor devices. In addition, the process is very simplified to realize an improvement in the process yield and mass production.

### TECHNICAL FIELD

The present invention relates to a solder paste, and more particularly, to a solder paste containing a UV degradable or curable polymer and a fine solder powder mixed with each other and a method for forming solder bumps using the solder paste.

### BACKGROUND ART

In order to connect a chip to an external substrate such as a printed circuit board (PCB), generally a wire bonding method, a taped automated bonding method, a flip chip method or the like is employed.

Among them, the flip chip method has a short electron pathway and thus provides advantages that the speed and power can be improved and the number of pads per unit area can be increased. Therefore, this method has been widely employed in various applications ranging from a super computer requiring good electrical properties to portable electronic devices.

On the other hand, the flip chip method requires formation of solder bumps on the wafer, for the purpose of a solid-bonding between the chip and the external board. Techniques for forming these solder bumps have been developed in quest of solder bumps having a good conductivity, a uniform height and a fine pitch.

In the bump formation technique for the flip chip method, the properties of solder bumps and its application range are determined depending upon the bumping materials. Typical bump formation methods include a solder ball array technique, where solder balls are placed directly on a substrate, an electroplating method and a stencil printing method, where solder bumps are formed by reflowing after an intermediate step.

However, the conventional solder bump formation methods entail shortcomings in that a dedicated facility of high cost is required, or various complicated processes such as exposure, developing, plating and etching are needed, thereby leading to a significant decrease in the productivity and process yield.

Furthermore, in order to form solder bumps of fine size, a complicated process is required. Thus, the conventional techniques cannot control the uniformity of solder bumps being formed and thus practically cannot be applied to miniaturized devices. In particular, this conventional method can hardly be applied to solder bumps having a fine size of less than 80 μm.

### DISCLOSURE OF INVENTION

### Technical Problem

Accordingly, the present invention has been made in an effort to solve the problems occurring in the prior art. It is an object of the invention to provide a solder paste capable of forming a fine solder bump pattern and a method of forming solder bumps using the solder paste.

### Technical Solution

To achieve the above object, according to an aspect of the invention, there is provided a solder paste comprising: 70 to 90 wt % of a solder powder; 5 to 15 wt % of an ultraviolet curable or degradable photosensitive polymer; 0.5 to 2 wt % of an additive; and 4.5 to 13 wt % of a composite solvent. The solder powder has a melting point of 100 to 250° C.

Preferably, the additive includes at least one of an amine polymer, a UV absorber, a thixo agent and a coupling agent. The solder powder includes an alloy powder containing at least one of Pb, Sb, Bi, Cu, Ag and Sn.

According to another aspect of the invention, there is provided a method for forming solder bumps using a solder paste. The method comprises the steps of: coating a solder paste on a substrate where solder bumps are to be formed; allowing of curing or degradation reaction using ultraviolet rays; developing the substrate to form a solder paste pattern; and reflowing the solder paste pattern by heating the substrate.

According to yet another aspect of the invention, there is provided a method for forming solder bumps using a solder paste. The method comprises the steps of: coating a solder paste on a transparent optical film to form a solder paste film; attaching the solder paste film on a substrate where solder bumps are to be formed; allowing of curing or degradation reaction using ultraviolet rays; developing the substrate to form a solder paste pattern; and reflowing the solder paste pattern by heating the substrate.

Here, it is preferable that the step of reflowing is carried out at a temperature of 120 to 300° C. Preferably, the substrate includes any one selected from the group consisting of a printed circuit board (PCB), a multi-layer board (MLB), a ball grid array (BGA) board, a package board and a semiconductor board. The step of coating is carried out through any one selected from the group consisting of a die coater, a roll coater, a doctor blade method and a bar coater.

In a method for forming solder bumps using a solder paste film, the film preferably includes any one selected from the group consisting of a polyester film, a polyethylene terephthalate film, a polycarbonate film, a polyethersulfone film, triacethylcellulose film, a polypropylene film, a polystyrene film, a polymethacrylate film, a polymethylmethacrylate film, a polyacrylate film and a polyamide film.

### Advantageous Effects

According to the present invention, the solder bumps can be formed so as to have a fine width of a few or a few tens of micrometers, thereby easily achieving miniaturization and increased integration of semiconductor devices. In addition, the process is very simplified to realize an improvement in the process yield and mass production.

### BRIEF DESCRIPTION OF THE DRAWINGS

FIG. 1 is a flow chart showing procedures for forming solder bumps according to the invention;

FIG. 2 is sectional views illustrating a process for forming solder bumps according to an embodiment of the invention; and

FIG. 3 is sectional views illustrating a process for forming solder bumps according to another embodiment of the invention.

<Explanation on the reference numerals on the main parts in the drawings>
200, 320: Substrate
210, 310: Solder paste
20, 330: Mask
250: Solder bump
300: Transparent optical polymer film

### MODE FOR THE INVENTION

Hereinafter, exemplary embodiments of the invention will be explained in details with reference to the accompanying drawings.

A solder paste according to the invention is a mixture of solder powers having a low melting temperature of no more than 250° C. and a UV (ultraviolet) curable or UV degradable photosensitive polymer. The solder paste of the invention can be used for easier formation of solder bumps.

Here, the solder paste includes an additive and a composite solvent, along with the solder powder and the photosensitive polymer.

In the solder paste according to the invention, the solder powder is formed of a solder of ultra-fine particle such as Pb, Sb, Bi, Cu, Ag, Sn, Sn/Pb, Sn/Ag, Sn/Sb, Sn/Zn, Sn/Bi, Sn/Pb/Bi, Sn/Pb/Ag, or Sn/Ag/Cu, and is mixed at a ratio of 70 to 90 wt %. At this time, the finer the particle size of the solder powder is, the more uniform and denser the formed solder bumps become.

The UV curable or degradable photosensitive polymer includes a photopolymerizable or degradable polymer, and is mixed at a ratio of 5 to 15 wt % in the solder paste.

At this time, a photoinitiator to be contained in the photosensitive polymer includes, for example, benzoins, benzoin alkyl ethers such as benzoin methyl ether, acetone phenons such as acetophenone, amino acetophenones such as 2-methyl-1-[4-(methylthio)phenyl]-2-morpholinopropanone-1,2-benzyl-2-dimethylami no-1-(4-morpholinopethly)-buthanone-1, anthraquinones such as 2-methylanthraquinone and 2-ethylanthraquinone, thioxanthones such as 2,4-dimethylthioxanthone, ketals such as acetophenonedimethylketal, benzophenones such as benzophenone, xanthones, triazines, imidazoles, phosphine oxides such as (2,6-dimethoxybenzoyl)-2,4,4-pentylphosphine oxide, or various peroxides, or any others which can produce radicals and initiate cross-linking reactions of polymers.

In addition, additives, which include amine polymers, UV absorbers, thixo agents, coupling agents and the like, are mixed at a ratio of 0.5 to 2 wt %, and a composite solvent is mixed at a ratio of 4.5 to 13 wt % to obtain a solder paste according to the invention.

At this time, examples for the composite solvent include ether alcohols such as ethylene glycol monomethyl ether and ethylene glycol monoethyl ether, saturated aliphatic monocarboxylic acid alkyl esters such as acetate-n-butyl and amyl acetate, lactic acid esters such as lactic acid ethyl and lactic acid-n-butyl, etheric esters such as methyl cellosolve acetate and ethyl cellosolve acetate, N-methyl-2- pynolidone, and a mixture of two or more thereof.

As described above, the solder paste according to the invention takes the form of a mixture of a photosensitive polymer and a solder powder, which can be used for easily forming solder bumps through a UV lithographic process. This process of the invention is simplified and cost-effective, as compared with conventional processes.

In addition, since the size of solder bump can be determined by means of degradation power of ultraviolet rays employed, a solder bump of no more than 80 μm can be easily formed.

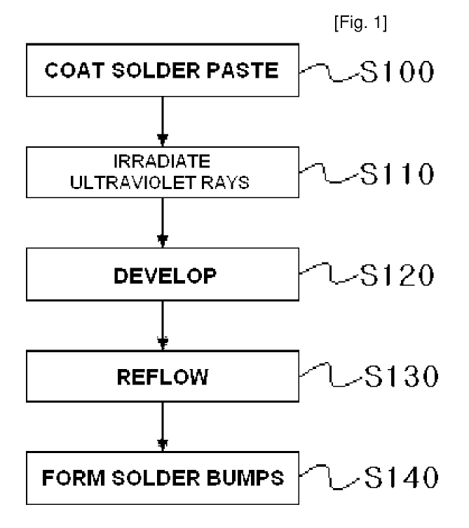

Hereafter, a method for forming solder bumps using a solder paste according to the invention will be explained with reference to FIGS. 1 to 3.

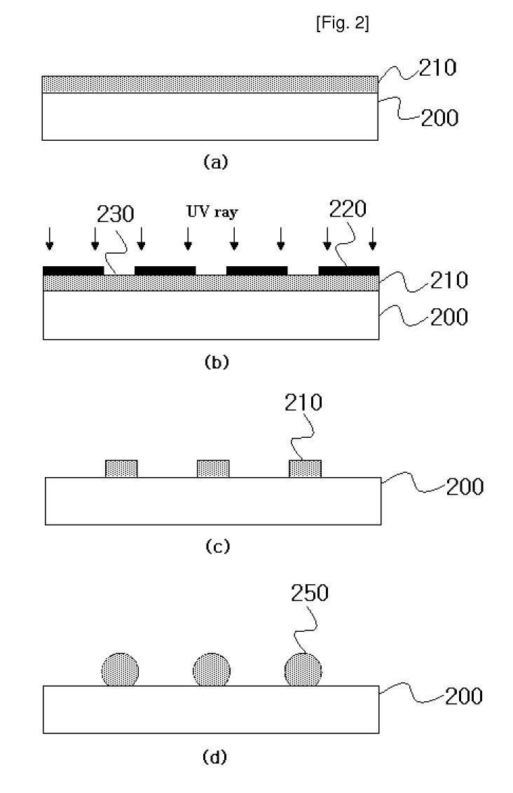

FIGS. 1 and 2 illustrate an embodiment of a method for forming solder bumps according to the invention. Specifically, FIG. 1 is a flow chart showing procedures for forming solder bumps according to the invention, and FIG. 2 is sectional views illustrating a process for forming solder bumps according to an embodiment of the invention.

As shown in FIG. 2(a), the solder paste 210 according to the invention is coated on a substrate 200 where solder bumps are to be formed (S100).

The substrate 200 to be formed with solder bumps includes, for example, a printed circuit board (PCB), a multi-layer board (MLB), a ball grid array (BGA) board, a package board, a semiconductor board, and the like. The solder paste 210 coating process employs a die coater, a roll coater, a doctor blade method, a bar coater, or the like.

At this time, the coating thickness of solder paste can be determined by carrying out the coating process in plural times, or by varying the rotation speed of a coater during the coating process, thereby enabling to determine the size of a solder bump.

After completing the coating process, a thermal treatment process can optionally be performed in addition to remove the composite solvent contained in the coated solder paste 210. At this time, it is preferable that the thermal treatment is carried out at a temperature less than the melting point of the solder powder contained in the solder paste 210.

Thereafter, as shown in FIG. 2(b), ultraviolet rays are radiated onto the solder paste 210 to form a solder paste pattern.

In this embodiment, the solder paste contains a photo-polymerizable polymer as the photosensitive polymer mixed therein. As shown in FIG. 2(b), a mask 220 is used to expose a solder bump forming area 230 before irradiating ultraviolet rays (S110).

In case where the solder paste is mixed with a photo-degradable polymer, the mask is configured to shield the solder bump forming area from ultraviolet rays.

Then, if the substrate irradiated with ultraviolet rays is developed (S120), the UV-exposed area is cured to form a solder paste 210 pattern, as shown in FIG. 2(c).

If a reflow process is performed onto the substrate formed with a solder paste 210 pattern (S130), solder bumps are formed as shown in FIG. 2(d) (S140).

At this time, the reflow process is carried out at a temperature higher than the melting point of the solder powder contained in the solder paste. In this embodiment, the solder powder contained in the solder paste has a melting temperature of 100 to 250° C. Thus, the reflow process is performed at a temperature of 120 to 300° C.

In the solder bump forming method according to an embodiment of the invention, ultraviolet rays are used to form a solder paste pattern and a solder bump is formed by reflowing the solder paste pattern. Therefore, depending upon the degradation power of UV rays, the solder bumps can be formed so as to have a fine width of a few or a few tens of micrometers, thereby easily achieving miniaturization and increased integration of semiconductor devices. In addition, the forming process is simplified to realize an improvement in the process yield and mass production.

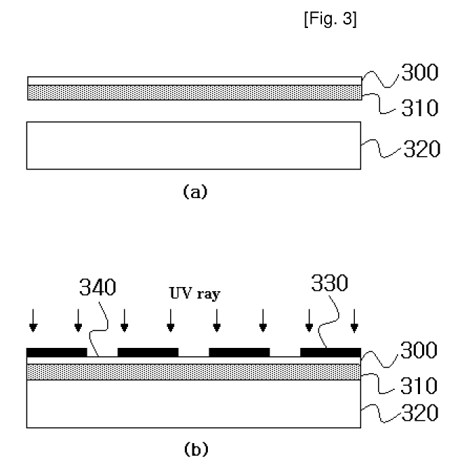

FIG. 3 illustrates a solder bump forming method using a solder paste film according to another embodiment of the invention. This embodiment will be explained referring to FIG. 3.

As shown in FIG. 3(a), a solder paste 310 according to the invention is coated on a transparent optical polymer film 300 to form a solder paste film.

Here, examples for the transparent optical polymer film 300 include a polyester film, a polyethylene terephthalate film, a polycarbonate film, a polyethersulfone film, triacethylcellulose film, a polypropylene film, a polystyrene film, a polymethacrylate film, a polymethylmethacrylate film, a polyacrylate film, a polyamide film or the like.

Thereafter, the solder paste film is attached on a substrate where solder bumps are to be formed. Then, as shown in FIG. 3(b), the processes for irradiating ultraviolet rays and forming a solder paste pattern, and the subsequent developing and reflowing processes are carried out in the same manner as in the previous first embodiment of the invention.

The terms and words used in the description and claims are not to be limited to ordinary meanings or dictionary definitions. Under the principles that the inventors are entitled to act as his or her own lexicographer in order to explain his or her own invention in the best way, those terms and words are to be construed so as to conform to the technical concept of the present invention.

The constructions disclosed in the specification and drawings show one preferred embodiment of the invention, not represent all the technical concepts of the invention. It is therefore understood that at the time of filing this application, various alternatives and modifications to these constructions may occur to those skilled in the art.

1. A solder paste comprising:
70 to 90 wt % of a solder powder;
5 to 15 wt % of an ultraviolet curable or degradable photosensitive polymer;
0.5 to 2 wt % of an additive; and
4.5 to 13 wt % of a composite solvent.

2. The solder paste according to claim 1, wherein the solder powder has a melting point of 100 to 250° C.

3. The solder paste according to claim 1, wherein the additive includes at least one of an amine polymer, a UV absorber, a thixo agent and a coupling agent.

4. The solder paste according to claim 2, wherein the solder powder comprises an alloy powder containing at least one of Pb, Sb, Bi, Cu, Ag and Sn.

5. A method for forming solder bumps using a solder paste, the method comprising the steps of;
coating a solder paste on a substrate where solder bumps are to be formed;
allowing of curing or degradation reaction using ultraviolet rays;
developing the substrate to form a solder paste pattern; and
reflowing the solder paste pattern by heating the substrate.

6. A method for forming solder bumps using a solder paste, the method comprising the steps of:
forming a solder paste film by coating a solder paste on a transparent optical film;
attaching the solder paste film on a substrate where solder bumps are to be formed;
allowing of curing or degradation reaction using ultraviolet rays;
developing the substrate to form a solder paste pattern; and
reflowing the solder paste pattern by heating the substrate.

7. The method according to claim 5 or 6, wherein the step of reflowing is carried out at a temperature of 120 to 300° C.

8. The method according to claim 5 or 6, wherein the substrate comprises any one selected from the group consisting of a printed circuit board, a multi-layer board, a ball grid array (BGA) board, a package board and a semiconductor board.

9. The method according to claim 5 or 6, wherein the step of coating is carried out through any one selected from the group consisting of a die coater, a roll coater, a doctor blade method and a bar coater.

10. The method according to claim 6, wherein the film includes any one selected from the group consisting of a polyester film, a polyethylene terephthalate film, a polycarbonate film, a polyethersulfone film, triacethylcellulose film, a polypropylene film, a polystyrene film, a polymethacrylate film, a polymethylmethacrylate film, a polyacrylate film and a polyamide film.
